(19) United States
(12) Patent Application Publication
(10) Pub. No.: US 2022/0383093 A1
(43) Pub. Date: Dec. 1, 2022

(54) Leveraging and Training an Artificial Intelligence Model for Control Identification

(71) Applicant: International Business Machines Corporation, Armonk, NY (US)

(72) Inventors: Abdulhamid Adebowale Adebayo, White Plains, NY (US); Muhammed Fatih Bulut, West Greenwich, RI (US); Sai Zeng, Yorktown Heights, NY (US); Milton H. Hernandez, Tenafly, NJ (US)

(73) Assignee: International Business Machines Corporation, Armonk, NY (US)

(21) Appl. No.: 17/330,771

(22) Filed: May 26, 2021

(51) Int. Cl. G06N 3/08; G06K 9/62

(52) U.S. Cl. CPC G06N 3/08; G06K 9/6256; G06K 9/6215

(57) ABSTRACT

A computer system, program code, and a method are provided to leverage an AI model with respect to a target specification for a target standard. The AI model is configured to identify at least one candidate control associated with a corresponding standard. A map is subject to traversal to identify the candidate control in the map. Source and destination controls of the map are leveraged to identify at least one mapped control associated with the target standard. The AI model is selectively subject to training with the mapped control and the target standard.

### BACKGROUND

The present embodiments relate to a system, a computer program product, and a method for leveraging of an artificial intelligence (AI) model to identify controls, such as security and privacy controls, and training of the AI model to improve its technological effectiveness.

Security compliance and privacy compliance are processes of ensuring that adequate levels of security-related and privacy-related requirements are satisfied. Such requirements are typically set forth in regulations, although the requirements may be found in other sources, such as laws, executive orders, directives, policies, guidelines, standards, etc. In a typical (but not exhaustive) scenario, a regulation or other legal requirement is issued by a governmental body, typically an administrative agency or a (federal or state) legislature, which specifies requirements (e.g., technical requirements) relating to such matters as protection of public-sector and private-sector organizational operations and assets (e.g., data) from security and privacy risks. Such security and privacy risks may arise from, for example, threatening actors attempting to exploit information technology system and product vulnerability, natural disasters, power failures, passive threats such as human error, and other threats, both external and internal. Compliance with such legal requirements is prudent, cost preventative, and in many cases mandatory to avoid violations of the laws and other legal requirements.

Information and security and privacy standards are often approved by a recognized private-sector or public-sector standards body or organization. Cyber-security standards, for example, set forth technical specifications for the protection of data and enforcement of information security. Compliance with specifications of such standards is highly desirable or even mandatory for industry acceptance. Standards typically are organization specific (e.g., NIST, HIPPA, etc.). Examples of standards include, for example, National Institute of Standards and Technology (NIST) standards, Health Insurance Portability and Accountability Act (HIPAA) standards, Payment Card Industry Data Security Standards (PCI-DSS), International Organization for Standardization (ISO) standards, General Data Protection Regulation (GDPR), and others.

Ensuring compliance with various security-related and privacy-related requirements that may apply to a given organization requires an exercise of due diligence in not only implementing adequate protections, but maintaining and updating such protections as regulations, laws, etc. are amended, rewritten, rescinded, and promulgated, and as new surreptitious attack means are identified. To meet these requirements, security and privacy controls (hereinafter collectively referred to as “controls”) have been developed and implemented by organizations, both in the private sector and the public sector, and by individuals to safeguard information technology and other systems, computing platforms, devices, and products. Organizations or individuals select and implement controls to satisfy security-related and privacy-related requirements.

Controls have been described as technical, administrative, or physical safeguards and protection capabilities that may detect, prevent, lessen, and/or counteract a security risk, such as, for example, a threatening actor's ability to exploit a vulnerability. For example, National Institute of Standards and Technology (NIST) provides access via its website to the publication “Security and Privacy Controls for Information Systems and Organizations,” NIST Special Publication 800-53, Rev. 5 (September 2020). The publication discloses control structures including a base control section (prescribing a security and/or privacy capability to be implemented), a discussion section, a related controls section, a control enhancements section, and a reference section.

Standards of one standards organization can be mapped to standards of one or more other standards organizations. Controls directly map to standards, since control testing is designed, for example, to measure aspects of how standards are implemented in practice. A control check is a verification of compliance with one or more controls across one or more standards.

Often, multiple standards are developed by different standards organizations or bodies that relate to the same (or similar) security or privacy requirements. As a consequence, controls of a given standard of one standards organization may share similarities with one or more controls of another standard of another standards organization. It would therefore be advantageous to provide a system, a computer program product, and a method that promote leveraging of an artificial intelligence (AI) model for identifying security and privacy controls, and for incorporating standards mapping into training of the AI model to advance and improve the AI model's technological effectiveness.

### SUMMARY

The embodiments include a system, a computer program product, and a method for leveraging of an artificial intelligence (AI) model to identify controls, such as security and privacy controls, and training of the AI model to improve its technological effectiveness. This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

In one aspect, a computer system is provided with a processor operatively coupled to memory, and a platform in communication with the processor and the memory. The platform includes an artificial intelligence (AI) manager, a mapping manager, and a training manager. The AI model manager is configured to leverage an AI model with respect to a target specification for a target standard. The AI model is configured to identify at least one candidate control associated with a corresponding standard. The mapping manager is configured to traverse a map comprising source and destination controls. The traversal includes identifying the at least one candidate control in the map and traversing the source and destination controls of the map to identify at least one mapped control associated with the target standard. The training manager is configured selectively train the AI model with the mapped control and the target standard.

In another aspect, a computer program product is provided to utilize artificial intelligence (AI) and a corresponding AI model to facilitate mapping a control to a target standard. The computer program product includes a computer readable storage medium having program code embodied therewith. The program code is executable by a processor configured to leverage an AI model with respect to a target specification for a target standard. The AI model is configured to identify at least one candidate control associated with a corresponding standard. The program code is further executable by the processor to traverse a map comprising source and destination controls. The traversal comprises identifying at least one candidate control in the map and traversing the source and destination controls of the map to identify at least one mapped control associated with the target standard. The program code is further executable by the processor to selectively train the AI model with the mapped control and the target standard.

In yet another aspect, a method is provided that includes leveraging an artificial intelligence (AI) model with respect to a target specification for a target standard. The AI model identifies at least one candidate control associated with a corresponding standard. A map comprising source and destination controls is traversed. The traversal comprises identifying at least the candidate control in the map, and traversing the source and destination controls of the map to identify at least one mapped control associated with the target standard. The AI model is selectively trained with the mapped control and the target standard.

According to still another aspect, a computer system is provided with a processor operatively coupled to memory, and a platform in communication with the processor and the memory. The platform includes an artificial intelligence (AI) manager, a mapping manager, and a training manager. The AI model manager is configured to leverage an AI model with respect to a target specification for a target standard. The AI model is configured to identify at least one candidate control associated with a corresponding standard. The mapping manager is configured to traverse a map comprising source and destination controls. The traversal includes identifying the at least one candidate control in the map and traversing the source and destination controls of the map to identify at least one mapped control associated with the target standard. The mapping manager is configured to identify a quantity of identified mapped controls. In response to the quantity of identified mapped controls being outside of a predetermined range or not satisfying a predetermined limitation, the mapping manager is configured to change a parameter of the traversal and re-traverse the source and destination controls of the map using the changed parameter. The training manager is configured selectively train the AI model with the mapped control and the target standard.

According to a further aspect, a method is provided that includes leveraging an artificial intelligence (AI) model with respect to a target specification for a target standard. The AI model identifies at least one candidate control associated with a corresponding standard. A map comprising source and destination controls is traversed. The traversal comprises identifying at least the candidate control in the map, and traversing the source and destination controls of the map to identify at least one mapped control associated with the target standard. A quantity of identified mapped controls is identified. In response to the quantity of identified mapped controls being outside of a predetermined range or not satisfying a predetermined limitation, a parameter of the traversal is changed. The source and destination controls of the map are re-traversed using the changed parameter. The AI model is selectively trained with the mapped control and the target standard.

These and other features and advantages will become apparent from the following detailed description of the exemplary embodiment(s), taken in conjunction with the accompanying drawings, which describe and illustrate various systems, sub-systems, devices, apparatus, models, processes, and methods of additional aspects.

### BRIEF DESCRIPTION OF THE SEVERAL VIEWS OF THE DRAWINGS

The drawings referenced herein form a part of the specification, and are incorporated herein by reference. Features shown in the drawings are meant as illustrative of only some embodiments, and not of all embodiments, unless otherwise explicitly indicated.

FIG. 1 depicts a schematic diagram of a computer system to support and enable leveraging and training an AI model for control identification.

FIG. 2 depicts a block diagram illustrating the AI platform tools, as shown and described in FIG. 1, and their associated application program interfaces (APIs).

FIGS. 3A and 3B collectively depict a flow chart illustrating an embodiment of a method for leveraging and training an AI model for control identification.

FIG. 4 depicts a flow chart illustrating an embodiment of a modification to the flow chart of FIGS. 3A and 3B.

FIG. 5 depicts a fragmented view of an example of a relationship map according to an embodiment.

FIG. 6 depicts a block diagram illustrating an example of a computer system/server of a cloud based support system, to implement the system and processes described above with respect to FIGS. 1-5.

FIG. 7 depicts a block diagram illustrating a cloud computer environment.

FIG. 8 depicts a block diagram illustrating a set of functional abstraction model layers provided by the cloud computing environment.

### DETAILED DESCRIPTION

It will be readily understood that the components of the exemplary embodiments, as generally described and illustrated in the Figures herein, may be arranged and designed in a wide variety of different configurations. Thus, the following detailed description of the embodiments of the system, the computer program product, and the method and other aspect described herein, as presented in this description and the accompanying Figures, is not intended to limit the scope of the embodiments, as claimed, but is merely representative of selected embodiments.

Reference throughout this specification to “a select embodiment,” “one embodiment,” or “an embodiment” means that a particular feature, structure, or characteristic described in connection with the embodiment is included in at least one embodiment. Thus, appearances of the phrases “a select embodiment,” “in one embodiment,” or “in an embodiment” in various places throughout this specification are not necessarily referring to the same embodiment. It should be understood that the various embodiments may be combined with one another and that any one embodiment may be used to modify another embodiment.

The illustrated embodiments will be best understood by reference to the drawings, wherein like parts are designated by like numerals throughout. The following description is intended only by way of example, and simply illustrates certain selected embodiments of devices, systems, and processes that are consistent with the embodiments as claimed herein.

In the field of information technology (IT), compliance is directed at taking appropriate control of and protecting information. Internal compliance revolves around policies, goals, and organizational structure. External considerations are directed at satisfying a client or end user, while protecting data and internal structures. For example, IT compliance utilizes rules and standards that IT systems should follow to protect an underlying organization or structure, both from a security standpoint and a privacy standpoint. Compliance risk measures the extent of vulnerability a system or system component may have with respect to, e.g. an adversarial attack, a natural disaster, a power failure, human error, etc., because an organization is not adhering to a set of rules or standards. Risk management is directed at mitigating and managing risk through one or more controls.

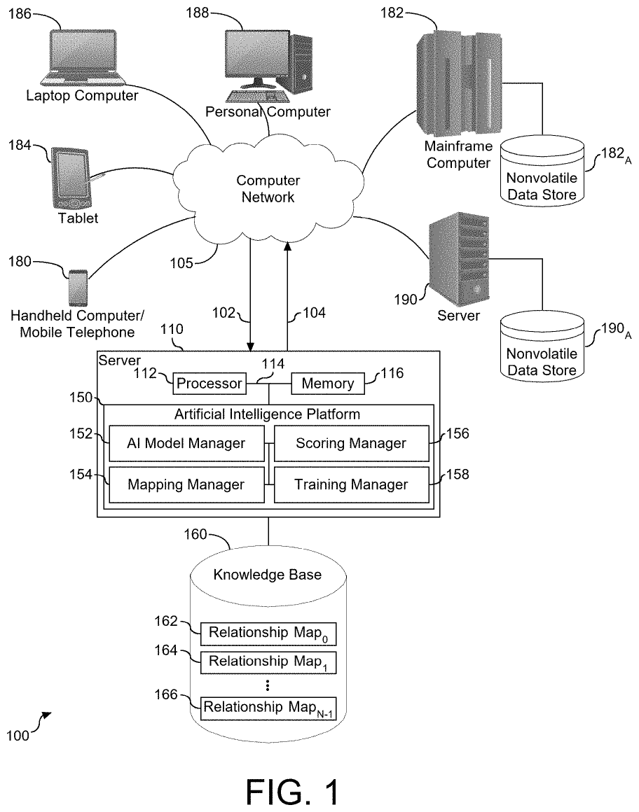

Referring to FIG. 1, a schematic diagram of a platform computing system (100) is depicted. In an exemplary embodiment, the platform includes or incorporates an artificial intelligence (AI) platform. As shown, a server (110) is provided in communication with a plurality of computing devices (180), (182), (184), (186), (188), and (190) across a network connection (105). The server (110) is configured with a processing unit (also referred to herein as a processor) (112) in communication with memory (116) across a bus (114). The server (110) is shown with an artificial intelligence (AI) platform (150) for cognitive computing, including natural language processing (NLP) and machine learning (ML), over the network (105) from one or more of the computing devices (180), (182), (184), (186), (188), and (190). More specifically, the computing devices (180), (182), (184), (186), (188), and (190) communicate with each other and with other devices or components via one or more wired and/or wireless data communication links, where each communication link may comprise one or more of wires, routers, switches, transmitters, receivers, or the like. In this networked arrangement, the server (110) and the network connection (105) enable communication detection, recognition, and resolution. Other embodiments of the server (110) may be used with components, systems, sub-systems, and/or devices other than those that are depicted herein.

The AI platform (150) is shown herein configured with tools to leverage an AI model (140) to predict controls, such as security and privacy controls, for a regulation or other requirement, and to train the AI model (140) to improve its performance. The tools include, but are not limited to, an AI model manager (152), a mapping manager (154), a scoring manager (156), and a training manager (158). Although FIG. 1 shows each of the tools (152), (154), (156), and (158) as part of the AI platform (150), it should be understood that in an embodiment the mapping manager (154), the scoring manager (156), the training manager (158), or any combination thereof are not necessarily part of the AI platform (150) or AI operated, and may be separately in operable communication with the processor (112) and memory (116).

Artificial Intelligence (AI) relates to the field of computer science directed at computers and computer behavior as related to humans. AI refers to the intelligence when machines, based on information, are able to make decisions, which maximizes the chance of success in a given topic. More specifically, AI is able to learn from a dataset to solve problems and provide relevant recommendations. For example, in the field of artificial intelligent computer systems, natural language systems (such as the IBM Watson® artificially intelligent computer system or other natural language interrogatory answering systems) process natural language based on system-acquired knowledge. To process natural language, the system may be trained with data derived from a database or corpus of knowledge, but the resulting outcome can be incorrect or inaccurate for a variety of reasons.

Machine learning (ML), which is a subset of Artificial Intelligence (AI), utilizes algorithms to learn from data and create foresights based on this data. AI refers to the intelligence when machines, based on information, are able to make decisions, which maximizes the chance of success in a given topic. More specifically, AI is able to learn from a dataset to solve problems and provide relevant recommendations. Cognitive computing is a mixture of computer science and cognitive science. Cognitive computing utilizes self-teaching algorithms that use minimum data, visual recognition, and natural language processing to solve problems and optimize human processes.

At the core of AI and associated reasoning lies the concept of similarity. The process of understanding natural language and objects requires reasoning from a relational perspective that can be challenging. Structures, including static structures and dynamic structures, dictate a determined output or action for a given determinate input. More specifically, the determined output or action is based upon an express or inherent relationship within the structure. Adequate datasets are relied upon for building those structures.

The AI platform (150) is shown herein configured to receive input (102) from various sources. For example, the AI platform (150) may receive input, such as a target specification for a target standard, across the network (105) from one or more of the plurality of computing devices (180), (182), (184), (186), (188), and (190). Furthermore, and as shown herein, the AI platform (150) is operatively coupled to a knowledge base (160), which is also referred to herein as a corpus or a database.

In an exemplary embodiment, the AI model manager (152) leverages an AI model (140) for control identification. In exemplary embodiments, the AI model (140) is, for example, a classification model or a text-similarity based search model. In exemplary embodiments, the AI model (140) is a machine learning model, a neural network, or a support vector machine. In an exemplary embodiment, the AI model (140) is pre-trained with existing classified control descriptions to receive a target specification (e.g., “minimum password length must be seven characters”) and a target standard (e.g., PCI/DSS), and to identify at least one candidate control associated with a corresponding standard (e.g., NIST IA-5(1)) and a corresponding score (also referred to herein as the “first score”). The candidate controls may include, for example, a control correlation identifier (CCI), a base control section, a discussion section, a related controls section, a control enhancements section, and a reference section. The AI model (140) may consider any combination of sections or the entirety of the candidate controls.

Often, multiple candidate controls are identified by the AI model (140). One reason for the identification of multiple candidate controls is that the language of the target specification differs across standards despite the existence of similar content and are often subject to different interpretations due to being text based. Indeed, the level of granularity also differs across different standards. Further, verifying compliance with a standard often leads to duplicate control checks.

In an exemplary embodiment, the at least one candidate control, and more often the plurality of candidate controls, identified by the AI model (140) shares one or more features or otherwise possesses one or more similarities to the inputted targeted specification. According to exemplary embodiments, the similarities may be text based and/or meta-data based. According to an exemplary embodiment, the identification of a corresponding score by the AI model (140) includes an assessment of the corresponding score. For example, the score may be a confidence score reflecting the similarity between the target specification and the identified at least one candidate control (or any part of a control structure of the candidate control, such as the CCI or discussion section of the control structure). Cosine similarity may be used to measure the similarity between vectors (generated by known vectorization techniques) of the target specification and the candidate control for the purpose of assessing the score. In an exemplary embodiment, semantic similarity is assessed.

According to an embodiment, where (i) the confidence score (e.g., 0.7) identified by the AI model manager (152) is greater than and hence satisfies a predetermined first threshold value (e.g., 0.5) and (ii) the standard (e.g., PCI/DSS) associated with the candidate control (e.g., 8.2.3) matches the target standard (e.g., PCI/DSS), the candidate control (e.g., 8.2.3.) is deemed an acceptable match to the target standard. Because the candidate control is an acceptable match, the candidate control is accepted as output without leveraging a relationship map.

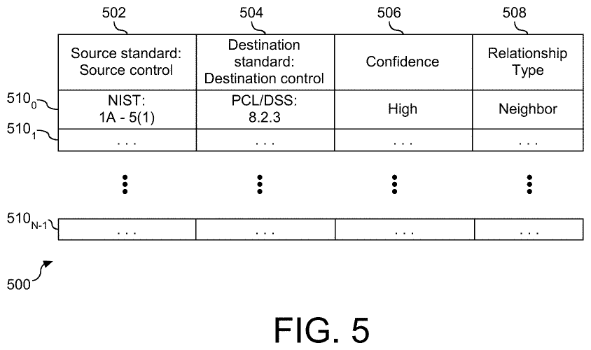

On the other hand, if the candidate control is not acceptable output, the mapping manager (154) is used to traverse one or more relationship maps (discussed in further detail with reference to FIG. 5 below) comprising source and destination controls. According to exemplary embodiments, the relationship map is (or relationship maps are) collections of known, predetermined relationships of controls between and across standards.

As shown in FIG. 1, the AI platform (150) is further shown in communication with knowledge base (160), also referred to herein as a corpus. Although only one knowledge base (160) is shown in FIG. 1, it should be understood that the system (100) may include additional knowledge bases. The illustrated knowledge base (160) is shown populated with a plurality of relationship maps, including Relationship Map₀ (162), Relationship Map₁ (164), . . . and Relationship Map_{N-1} (166), where N may be any integer. While three relationship maps are illustrated in FIG. 1, it should be understood that the knowledge base (160) may include fewer or additional relationship maps. In an exemplary embodiment, a single relationship map is accessed. The relationship maps are shown and described herein for descriptive purposes.

According to an embodiment, the candidate control (identified by the AI model (140)) may be deemed an unacceptable match for the target specification if the candidate control is associated with a corresponding standard that is different than the target standard. As an example, the AI model (140) may output a candidate control (e.g., IA-5(1)) associated with a standard (e.g., NIST) that differs from the target standard (e.g., PCI/DSS) input into the AI model (140).

According to another embodiment, the candidate control (identified by the AI model (140)) may be deemed an unacceptable match for the target specification where the AI model (140) identifies a first score for the candidate control that fails to satisfy a first threshold. For example, in the case that the first score for a given candidate control is relatively low, e.g., 0.3, and the predetermined threshold value is greater than the first score, e.g., the threshold value is 0.5, the candidate control is not an acceptable match for the target specification.

In the event the candidate control is not an acceptable match for the target specification, e.g., due to non-matching standards and/or a low first score, the system employs the mapping manager (154) to traverse a relationship map to find a “mapped” control.

The mapping manager (154) is configured to traverse a relationship map comprising source and destination controls, including to identify the at least one candidate control in the map and traverse the source and destination controls of the map to identify at least one mapped control associated with the target standard.

According to an embodiment, the mapping manager (154) is configured to identify the at least one candidate control in the relationship map comprising source and destination controls, and to traverse source and destination controls of the relationship map to identify at least one mapped control associated with the target standard. The identified candidate control may correspond to a source control or a destination control of the relationship map. For example, in an embodiment, if the identified candidate control is a source control in the relationship map, the traversal involves identifying the destination control matched to the source control. On the other hand, if the identified candidate control is a destination control in the relationship map, the traversal involves identifying the source control matched to the destination control according to an embodiment.

Referring now to FIG. 5, a fragmented view of an embodiment of a relationship map (500) according to an embodiment is shown. According to various embodiments, the relationship map (500) is prepared by one or more subject matter experts (SMEs), other persons, and/or by an automated program.

The relationship map (500) of FIG. 5 is embodied as a data structure, which in an embodiment and as shown herein, is in the form of a table including four columns, although it should be understood that relationship maps including fewer or more columns or structures other than that of a table as shown in FIG. 5 may be employed. The columns include a source column (502) including source controls and associated standards, a destination column (504) including destination controls and associated standards, a confidence column (506), and a relationship type column (508). The relationship map (500) further includes a plurality of rows (510₀), (510₁), . . . (510_{N-1}) representing mappings of source controls/standards (502) to destination control/standards (504), wherein N may be an integer between one and infinity, and typically is in the hundreds, thousands, or millions.

For explanatory purposes, an example is provided in row (510₀) in which a source control/standard NIST:1A-5(1) is mapped to a destination control/standard PCI/DSS:8.2.3. (The terms “source” and “destination” are arbitrarily applied between the matched pair, i.e., PCI/DSS:8.2.3 may be the source control/standard and NIST:1A-5(1) may be the destination control standard.) Other standards that may be included in the rows of the relationship map (500) may include, for example, HIPPA, ISO, GDPR, Defense Information Systems Agency (DISA), Security Technical Implementation Guide (STIG), and various other standards. The confidence column (506) represents a value associated with the similarity or relationship between the source and destination pair for a given row demonstrating a corresponding relationship. For example, for row (510₀), the assessed confidence is “High” for the relationship between NIST:1A-5(1) and PCI/DSS:8.2.3. Alternatively, the confidence column (506) may record numerical values (e.g., between 0 and 1), grades, or other values or indicia to represent confidence. The relationship type column (508) represents the relationship between the source and destination pair for a given row. According to an exemplary embodiment, the relationship refers to relationships in a standard hierarchical structure, such as, for example, parent, child, sibling, neighbor, etc. In row (510₀) of FIG. 5, the relationship type is “Neighbor.”

According to another embodiment, the computer system (100), and more particularly the server (110), is configured to subject the traversal of the relationship map to at least one parameter or restriction. According to an embodiment, the parameter comprises a relationship confidence rating (or level). For example, the parameter may require a relationship of at least “High” in the confidence column (506) in FIG. 5 in order to identify a mapped control as output. If, for example, the “High” confidence level identified too few mapped controls, the acceptable confidence level may need to be changed, such as a change to “Medium.” According to an embodiment, the mapping manager (154) changes the confidence level.

According to another embodiment, the parameter or restriction for traversal of the relationship map comprises a limit of the quantity of intermediate nodes between the source or destination controls in a hierarchical structure in order to identify a mapped control as output. For example, in a hierarchical structure, not all nodes are directly connected to one another by a single edge. Rather, there may be one, two, three, four, or more intermediate nodes (with corresponding two, three, four, five or more edges, respectively) between a neighboring relationship pair. For example, in the case of a source node representing a great grandchild and a destination node representing a great grandparent, there are two intermediate nodes. The source node representing the great grandchild is connected by a first edge to a first intermediate node representing a parent, the first intermediate node representing the parent is connected by a second edge to a second intermediate node representing the grandparent, and the second intermediate node representing the grandparent is connected by a third edge to the destination node representing the great grandparent. Hence, there are two intermediate nodes between the great grandchild source node and the great grandchild destination node. In this example, if the limit on the quantity of intermediate nodes is set at one or less, the relationship between the great grandchild source node and the great grandparent destination node (characterized by two intermediate nodes) would not be identified. On the other hand, if the limit on the quantity of intermediate nodes is set at two or less, the relationship between the great grandchild source node and the great grandparent destination node (characterized by two intermediate nodes) would be identified. According to an embodiment, the mapping manager (154) changes the acceptable quantity of intermediate nodes.

An exemplary embodiment of pseudocode for traversing a relationship map is set forth below:

```
Input: technical specification (s), target regulatory standard (t),
confidence = high, relationship map (map)
  traversal_list = [ ]
  for relationship(r) in map:
    rule_map = traverse(r, t, confidence)
      Note: r includes rₛ, r_{d}, r_{c}, and rₜ, where rₛ ᵢₛ a source regulatory
      standard, r_{d} is a destination regulatory standard, r_{c} is a relationship
      confidence rating, and rₜ is a relationship type
    traversal_list.append(rule_map)
  return traversal_list
```

The pseudo code for traverse(r, t, confidence) is set forth below:

```
if r_{c} = = confidence:
  if t = = rₛ:
    rule_map = fund entry for rule r_{d} in knowledge base
  if t = = r_{d}:
    rule_map = fund entry for rule rₛ in knowledge base
return rule_map
```

The traversal_list is a list of possible mappings. If the returned traversal_list is empty, then the relationship may need to be re-evaluated, which in an embodiment includes setting or re-setting the confidence in a manner to be more inclusive for consideration.

According to an embodiment and with reference to the platform computing system (100) of FIG. 1, the scoring manager (156) is configured to assess a second score representing similarity between the at least one mapped control output by the mapping manager (154) and the target specification. According to an exemplary embodiment, similarity is calculated based on embedding vectors derived from the text. Embedding techniques such as word2vec or language modeling techniques (e.g., transformers) can be used to derive a vector from text. Typically, the scoring manager (156) will assess additional scores (also referred to herein as “second scores,” wherein the “first scores” are described above with respect to leveraged AI model (140) for a plurality of mapped controls output by the mapping manager (154). According to an embodiment, the scoring manager (156) is further configured to rank the mapped controls based on the second scores. An example of pseudocode for the ranking is set forth below:

input: target specification string (s), traversal_list
unique_result = get unique results from the traversal list
map<string, float> similarity_rank
for result in unique_result:
similarity_rank.append(result, similarity(result, s))
sort similarity_rank
output: top ranked result.

As shown in line 5 of the pseudo-code, a score is generated, which in an embodiment may utilize one of many similarity assessments. In an exemplary embodiment, the similarity is a text-based assessment, which may employ a cosine similarity assessment of the control and the target specification.

According to an embodiment, the scoring manager (156) determines whether the score, also referred to herein as a second score, of each mapped controls falls above or below a threshold. According to an embodiment, if the second score (e.g., 0.7) is equal to or greater than and hence satisfies a predetermined second threshold value (e.g., 0.5), the mapped control is deemed an acceptable match to the target standard. According to an embodiment, if the second score (e.g., 0.3) is less than and hence fails to satisfy the predetermined second threshold value (e.g., 0.5), the mapped control is deemed an unacceptable match to the target standard.

In the event that the mapped control has an acceptable score or other confidence level to qualify the mapped control as an acceptable match for the target specification, the scoring manager (156) accepts the mapped control as output. The target specification is mapped to the mapped control.

In the event of a finding that the mapped control lacks an acceptable score or other confidence level to qualify the mapped control as an acceptable match for the target specification, a verification of this finding may be performed. According to an embodiment, the verification may be performed by an expert, such as a SME.

The training manager (158) is configured to selectively train the AI model (140) with the mapped control and the target specification if the verification reveals that the mapped control is an acceptable match for the target specification. If the verification reveals that the mapped control is not an acceptable match for the target specification, the training manager selects not to use the match for training the AI model (140).

The data source for the AI model (140) is the knowledge base, k. Below is pseudocode for enriching the knowledge base for the AI model (140), e.g., training the AI model (140), as discussed in further detail below:

```
  Input: tech spec(s), knowledge base (k)
  Result = top ranked result from AI model with string s as the input if
similarity(s, result) < 1.
  k_{ENRICHED} = k.add(s)
  Output: k_{ENRICHED}
```

In some illustrative embodiments, the server (110) may be the IBM Watson® system available from International Business Machines Corporation of Armonk, N.Y., which is augmented with the mechanisms of the illustrative embodiments described hereafter. The AI model manager (152), and optionally one or more of the mapping manager (154), the scoring manager (156), and the training manager (158), referred to collectively as tools, are shown as being embodied in or integrated within the AI platform (150) of the server (110). In an embodiment, the tools may be implemented in a separate computing system (e.g., server 190) that is connected across network (105) to the server (110). Wherever embodied, the tools function to support leveraging and training of an AI model for control identification. The tools function to select the ‘best’ matching controls and to further train the AI model.

Types of information handling systems that can utilize the AI platform (150) range from small handheld devices, such as handheld computer/mobile telephone (180) to large mainframe systems, such as mainframe computer (182). Examples of handheld computer (180) include personal digital assistants (PDAs), personal entertainment devices, such as MP4 players, portable televisions, and compact disc players. Other examples of information handling systems include pen, or tablet computer (184), laptop, or notebook computer (186), personal computer system (188), and server (190). As shown, the various information handling systems can be networked together using computer network (105). Types of computer network (105) that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems may use separate nonvolatile data stores (e.g., server (190) utilizes nonvolatile data store (190_{A}), and mainframe computer (182) utilizes nonvolatile data store (182a). The nonvolatile data store (182_{A}) can be a component that is external to the various information handling systems or can be internal to one of the information handling systems.

The information handling system employed to support the AI platform (150) may take many forms, some of which are shown in FIG. 1. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory. In addition, the information handling system may embody the north bridge/south bridge controller architecture, although it will be appreciated that other architectures may also be employed.

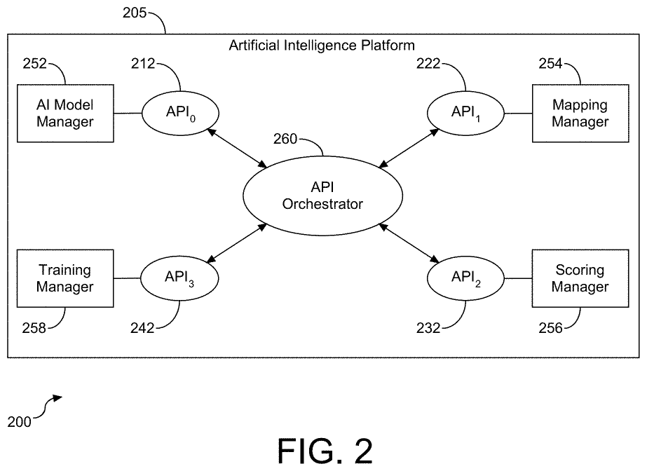

An Application Program Interface (API) is understood in the art as a software intermediary between two or more applications. With respect to the (AI) platform (150) shown and described in FIG. 1, one or more APIs may be utilized to support one or more of the tools (152), (154), (156), and (158) and their associated functionalities. Referring to FIG. 2, a block diagram (200) is provided illustrating the tools (152), (154), (156), and (158) and their associated APIs. As shown, a plurality of tools are embedded within the (AI) platform (205), with the tools including an AI model manager (252) associated with API₀ (212), a mapping manager (254) associated with API₁ (222), a scoring manager (256) associated with API₂ (232), and a training manager (258) associated with API₃ (242). Each of the APIs may be implemented in one or more languages and interface specifications.

As shown, API₀ (212) is configured to support and enable the functionality represented by the AI model manager (252). API₀ (212) provides functional support to access a pre-trained AI model, input target specifications with associated target standards into the AI model, and generate one or more candidate controls; API₁ (222) provides functional support to leverage a relationship map to traverse the map for identifying one or more mapped controls; API₂ (232) provides functional support to score and/or rank the mapped controls; and API₃ (242) provides functional support to selectively train the AI model. As shown, each of the APIs (212), (222), and (232) are operatively coupled to an API orchestrator (260), otherwise known as an orchestration layer, which is understood in the art to function as an abstraction layer to transparently thread together the separate APIs. In an embodiment, the functionality of the separate APIs may be joined or combined. In another embodiment, the functionality of the separate APIs may be further divided into additional APIs. As such, the configuration of the APIs shown herein should not be considered limiting. Accordingly, as shown herein, the functionality of the tools may be embodied or supported by their respective APIs.

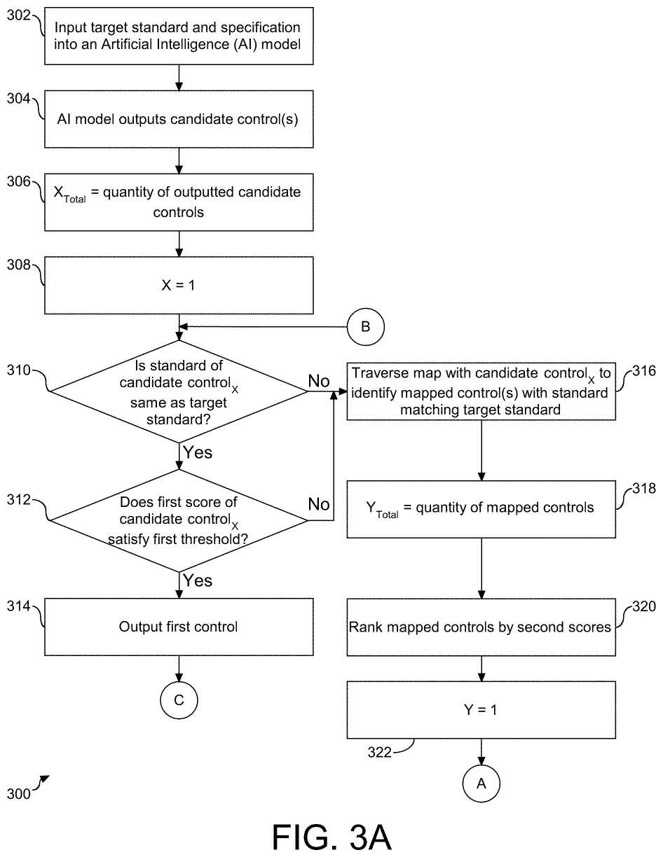

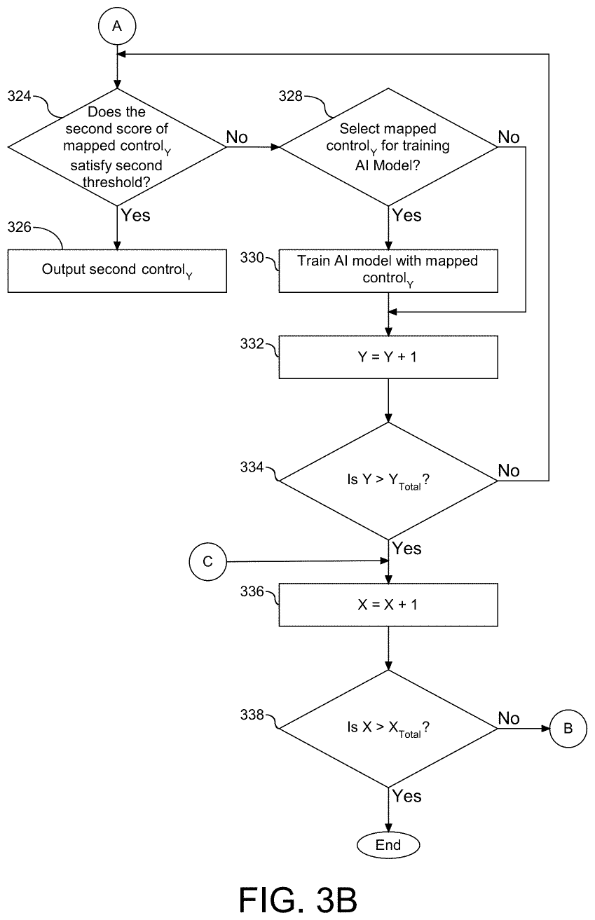

Referring collectively to FIGS. 3A and 3B, a flow chart (300) is provided illustrating an embodiment of a process (or method) for leveraging an AI model and a relationship map to identify one or more controls, and training the AI model.

In FIG. 3A, a target standard (e.g., PCI/DSS) and a target specification (e.g., “minimum password length 7 characters”) are input into a pre-trained AI model (302). The AI model generates output in the form of one or more candidate controls, each with an associated standard and a corresponding first score (304). The first score may be a numerical value, confidence level (e.g., high), or some other quantitative or qualitative score. The quantity of outputted candidate controls is identified and assigned to the variable X_{TOTAL} (306), and a corresponding candidate control counting variable X is initialized (308). A decision (310) is made whether the CandidateControl_{X} is associated with a corresponding standard that matches the target standard input into the AI model. A non-affirmative response to the decision (310) causes the process (300) to jump ahead to step (316), discussed below. An affirmative response to the decision (310) is followed by another decision (312) as to whether the first score of the CandidateControl_{X} satisfies a first threshold, which may be a quantitative or qualitative threshold. An affirmative response to the decision (312) is interpreted as an indication that the CandidateControl_{X} is an acceptable match for the target specification, and the CandidateControl_{X} is output (314), after which the candidate control counting variable, X, is incremented (336), as shown in FIG. 3B. On the other hand, a non-affirmative response to the decision (312) is followed by a traversal of the map (316). In an exemplary embodiment, the map is traversed with CandidateControl_{X} to identify one or more mapped controls with corresponding standards that match the target standard. The quantity of mapped controls is assigned value Y_{TOTAL} (318).

As shown in FIG. 3B, the process (300) continues with a ranking of the mapped controls (320), followed by an initialization of the mapped control counting variable, Y (322). In an exemplary embodiment, the ranking is performed using the corresponding “first scores” identified by the AI model (140) (in FIG. 1) leveraged to traverse the map. A decision (324) is made whether a second score associated with the MappedControl_{Y} satisfies a second threshold, e.g., a determined by the scoring manager. As with the first threshold, the second threshold may be quantitative or qualitative. For example, the second threshold may be a minimum score between zero (0) and one (1). In the exemplary embodiment described above, if the second score (e.g., 0.7) is equal to or greater than and hence satisfies a predetermined second threshold value (e.g., 0.5), the mapped control is deemed an acceptable match to the target standard. An affirmative response to the decision (324) is interpreted as an indication that MappedControl_{Y} is an acceptable match for the target specification, and the MappedControl_{Y} is output (326). According to an embodiment, if the second score (e.g., 0.3) is less than and hence fails to satisfy the predetermined second threshold value (e.g., 0.5), the mapped control is deemed an unacceptable match to the target standard, resulting in a non-affirmative response at the decision (324). According to an embodiment, if the second score (e.g., 0.3) is less than and hence fails to satisfy the predetermined second threshold value (e.g., 0.5), the mapped control is deemed an unacceptable match to the target standard, resulting in a non-affirmative response at the decision (324).

A non-affirmative response to the decision (324) is followed by a decision (328) as to whether MappedControl_{Y} is an acceptable match for the target specification. The decision (328) may be made manually, such as by a SME. In the event of a non-affirmative response to the decision (328), the variable Y is incremented (332). In the event of an affirmative response to the decision (328), the MappedControl_{Y} is used to train the AI model (330), and the variable Y is incremented (332). A decision (334) is then made whether the incremented value of Y is greater than Y_{TOTAL}. A non-affirmative response to the decision (334) causes a return to step (324). In the event of an affirmative response to the decision (336), the candidate control counting variable X is incremented (336) and a decision (338) is made whether the incremented value of X is greater than X_{TOTAL}. A non-affirmative response to decision (338) causes a return to step (310). An affirmative response to decision (338) ends the process (300).

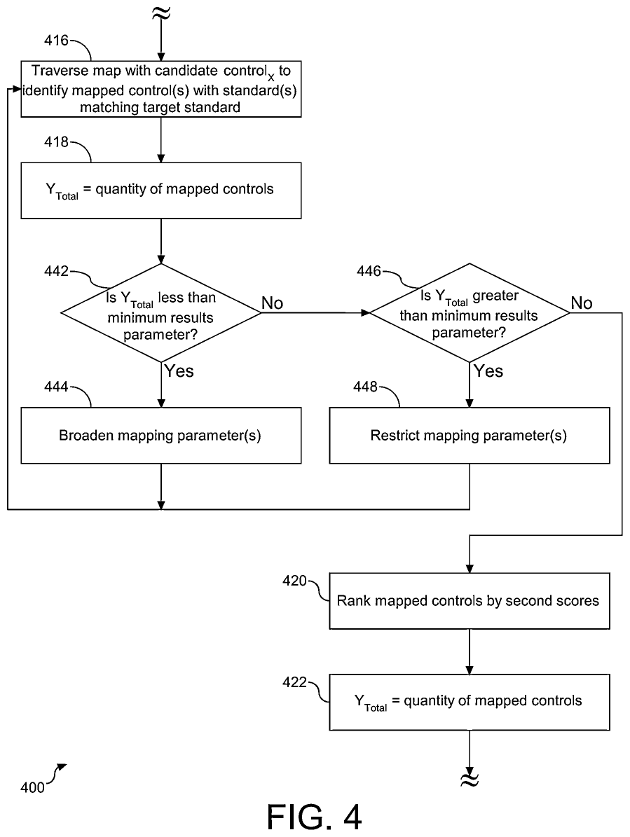

Referring to FIG. 4, a flow chart (400) depicts an embodiment involving a modification (or addition) to the process (300) of FIGS. 3A and 3B. Steps (416), (418), (420), and (422) correspond to steps (316), (318), (320), and (322), respectively, of FIGS. 3A and 3B. In the interest of brevity, the above description of steps (316), (318), (320), and (322) is incorporated herein with respect to steps (416), (418), (420), and (422). Steps (442), (444), (446), and (448) of FIG. 4 are additional steps that may be included in the process (300).

As shown, following step (418), a decision (442) is made whether the quantity of mapped controls Y_{TOTAL} is less than a minimum results parameter, which may represent a predetermined minimum population of mapping controls. An affirmative response to the decision (442) is followed by a broadening of the mapping parameters (e.g., an acceptable confidence level, the relationship type, etc.), followed by a return to step (416) for a renewed traversal of the relationship map and determination of Y_{TOTAL} (418).

A non-affirmative response to the decision (442) is followed by another decision (446) as to whether the quantity of mapped controls Y_{TOTAL} is greater than a maximum results parameter, which may represent a predetermined maximum population of mapping controls. An affirmative response to the decision (444) is followed by a restriction of the mapping parameters (e.g., raising the minimum confidence rating or level and/or lowering the intermediate node limit described above), followed by a return to step (416) for a renewed traversal or the relationship map and determination of Y_{TOTAL} A non-affirmative response to the decision (446) is interpreted as an indication that the quantity of mapped controls Y_{TOTAL} is acceptable, and the process (400) advances to step (420) for a ranking of the mapped controls and assignment of Y_{Total} to the quantity of mapped controls (422). In an exemplary embodiment, the ranking (420) is performed using the corresponding “first scores” identified by the AI model (140) (in FIG. 1) leveraged to traverse the map (416).

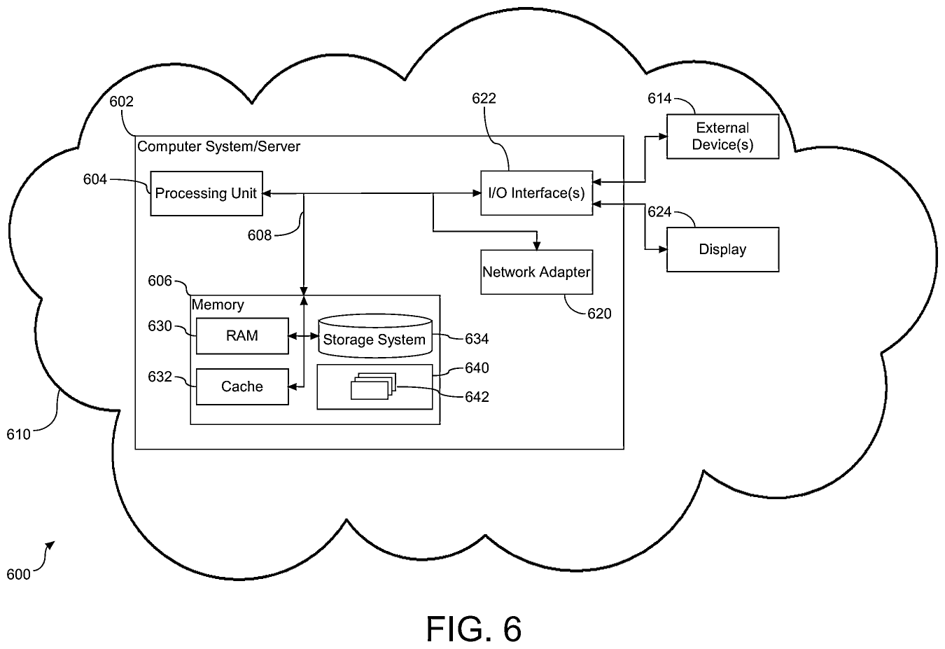

Aspects of leveraging an AI model for control identification, and training the AI model are shown and described with the tools and APIs shown in FIGS. 1 and 2, respectively, and the processes shown in FIGS. 3A, 3B, and 4. Aspects of the functional tools (152), (154), (156), and (158) and their associated functionality may be embodied in a computer system/server in a single location, or in an embodiment, may be configured in a cloud-based system sharing computing resources. With references to FIG. 6, a block diagram (600) is provided illustrating an example of a computer system/server (602), hereinafter referred to as a host (602) in communication with a cloud-based support system, to implement the processes described above with respect to FIGS. 3A, 3B, and 4. The host (602) is operational with numerous other general purpose or special purpose computing system environments or configurations. Examples of well-known computing systems, environments, and/or configurations that may be suitable for use with the host (602) include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and file systems (e.g., distributed storage environments and distributed cloud computing environments) that include any of the above systems, devices, and their equivalents.

The host (602) may be described in the general context of computer system-executable instructions, such as program modules, being executed by a computer system. Generally, program modules may include routines, programs, objects, components, logic, data structures, and so on that perform particular tasks or implement particular abstract data types. Host (602) may be practiced in distributed cloud computing environments (610) where tasks are performed by remote processing devices that are linked through a communications network. In a distributed cloud computing environment, program modules may be located in both local and remote computer system storage media including memory storage devices.

As shown in FIG. 6, the host (602) is shown in the form of a general-purpose computing device. The components of the host (602) may include, but are not limited to, one or more processors or processing units (604), e.g. hardware processors, a system memory (606), and a bus (608) that couples various system components including the system memory (606) to the processing unit (604). A bus (608) represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus. The host (602) typically includes a variety of computer system readable media. Such media may be any available media that is accessible by the host (602) and it includes both volatile and non-volatile media, removable and non-removable media.

The system memory (606) can include computer system readable media in the form of volatile memory, such as random access memory (RAM) (630) and/or cache memory (632). By way of example only, a storage system (634) can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus (608) by one or more data media interfaces.

A program/utility (640), having a set (at least one) of program modules (642), may be stored in the system memory (606) by way of example, and not limitation, as well as an operating system, one or more application programs, other program modules, and program data. Each of the operating systems, one or more application programs, other program modules, and program data or some combination thereof, may include an implementation of a networking environment. The program modules (642) generally carry out the functions and/or methodologies of embodiments to support and enable reinforcement learning through random action replay for natural language (NL). For example, the set of the program modules (642) may include the tools (152), (154), (156), and/or (158) as described in FIG. 1.

The host (602) may also communicate with one or more external devices (614), such as a keyboard, a pointing device, etc.; a display (624); one or more devices that enable a user to interact with the host (602); and/or any devices (e.g., network card, modem, etc.) that enable the host (602) to communicate with one or more other computing devices. Such communication can occur via Input/Output (I/O) interface(s) (622). Still yet, the host (602) can communicate with one or more networks such as a local area network (LAN), a general wide area network (WAN), and/or a public network (e.g., the Internet) via a network adapter (620). As depicted, the network adapter (620) communicates with the other components of the host (602) via the bus (608). In an embodiment, a plurality of nodes of a distributed file system (not shown) is in communication with the host (602) via the I/O interface (622) or via the network adapter (620). It should be understood that although not shown, other hardware and/or software components could be used in conjunction with the host (602). Examples, include, but are not limited to: microcode, device drivers, redundant processing units, external disk drive arrays, RAID systems, tape drives, and data archival storage systems, etc.

In this document, the terms “computer program medium,” “computer usable medium,” and “computer readable medium” are used to generally refer to media such as the system memory (606), including the RAM (630), the cache (632), and the storage system (634), such as a removable storage drive and a hard disk installed in a hard disk drive.

Computer programs (also called computer control logic) are stored in the system memory (606). Computer programs may also be received via a communication interface, such as the network adapter (620). Such computer programs, when run, enable the computer system to perform the features of the present embodiments as discussed herein. In particular, the computer programs, when run, enable the processing unit (604) to perform the features of the computer system. Accordingly, such computer programs represent controllers of the computer system.

In an embodiment, the host (602) is a node of a cloud computing environment. As is known in the art, cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models. Example of such characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher layer of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some layer of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is service oriented with a focus on statelessness, low coupling, modularity, and semantic interoperability. At the heart of cloud computing is an infrastructure comprising a network of interconnected nodes.

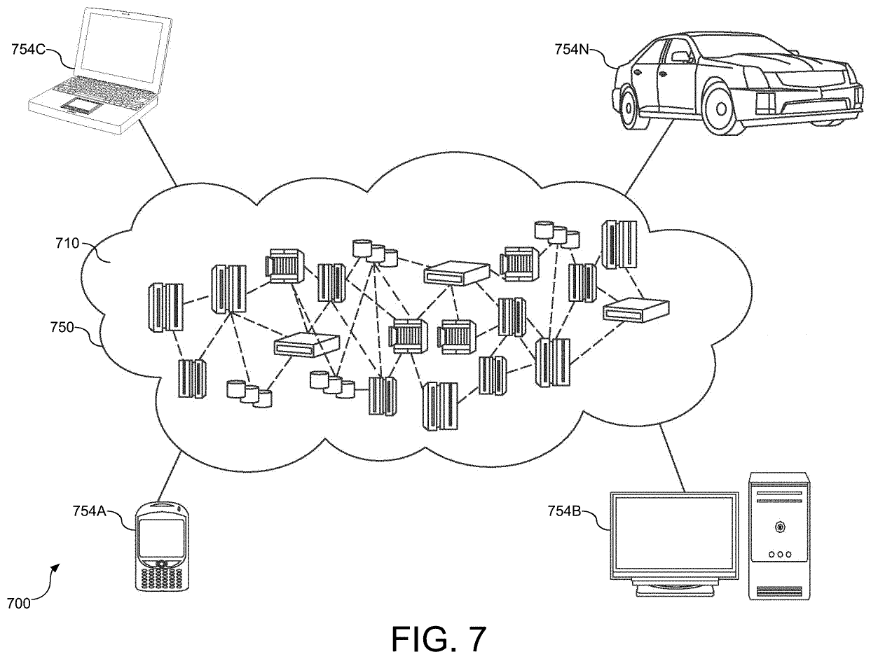

Referring now to FIG. 7, an illustrative cloud computing network (700) is shown. The cloud computing network (700) includes a cloud computing environment (750) having one or more cloud computing nodes (710) with which local computing devices used by cloud consumers may communicate. Examples of these local computing devices include, but are not limited to, a personal digital assistant (PDA) or a cellular telephone (754A), a desktop computer (754B), a laptop computer (754C), and/or automobile computer system (754N). Individual nodes within the cloud computing nodes (710) may further communicate with one another. They may be grouped (not shown) physically or virtually, in one or more networks, such as Private, Community, Public, or Hybrid clouds as described hereinabove, or a combination thereof. This allows the cloud computing environment (700) to offer infrastructure, platforms and/or software as services for which a cloud consumer does not need to maintain resources on a local computing device. It is understood that the types of computing devices (754A-N) shown in FIG. 7 are intended to be illustrative only and that the cloud computing environment (750) can communicate with any type of computerized device over any type of network and/or network addressable connection (e.g., using a web browser).

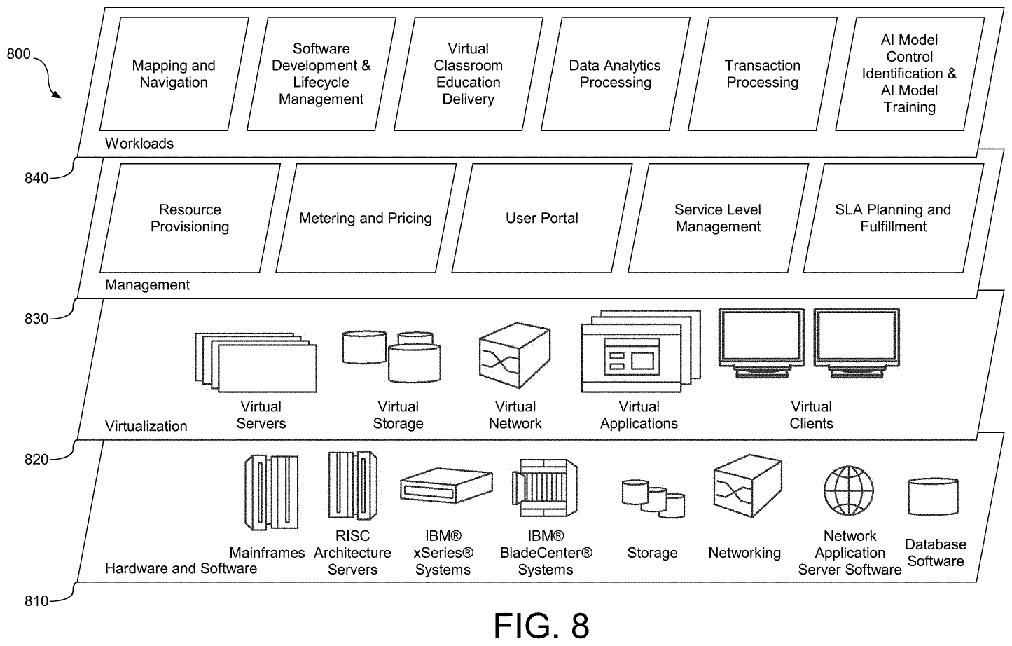

Referring now to FIG. 8, a set of functional abstraction layers (800) provided by the cloud computing network of FIG. 7 is shown. It should be understood in advance that the components, layers, and functions shown in FIG. 8 are intended to be illustrative only, and the embodiments are not limited thereto. As depicted, the following layers and corresponding functions are provided: a hardware and software layer (810), a virtualization layer (820), a management layer (830), and a workload layer (840).

The hardware and software layer (810) includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

The virtualization layer (820) provides an abstraction layer from which the following examples of virtual entities may be provided: virtual servers; virtual storage; virtual networks, including virtual private networks; virtual applications and operating systems; and virtual clients.

In one example, the management layer (830) may provide the following functions: resource provisioning, metering and pricing, user portal, service layer management, and SLA planning and fulfillment. Resource provisioning provides dynamic procurement of computing resources and other resources that are utilized to perform tasks within the cloud computing environment. Metering and pricing provides cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service layer management provides cloud computing resource allocation and management such that required service layers are met. Service Layer Agreement (SLA) planning and fulfillment provides pre-arrangement for, and procurement of, cloud computing resources for which a future requirement is anticipated in accordance with an SLA.

The workloads layer (840) provides examples of functionality for which the cloud computing environment may be utilized. Examples of workloads and functions which may be provided from this layer include, but are not limited to: mapping and navigation; software development and lifecycle management; virtual classroom education delivery; data analytics processing; transaction processing; and AI model control identification and AI model training.

While particular embodiments of the present embodiments have been shown and described, it will be obvious to those skilled in the art that, based upon the teachings herein, changes and modifications may be made without departing from the embodiments and its broader aspects. Therefore, the appended claims are to encompass within their scope all such changes and modifications as are within the true spirit and scope of the embodiments. Furthermore, it is to be understood that the embodiments are solely defined by the appended claims. It will be understood by those with skill in the art that if a specific number of an introduced claim element is intended, such intent will be explicitly recited in the claim, and in the absence of such recitation no such limitation is present. For a non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to embodiments containing only one such element, even when the same claim includes the introductory phrases “one or more” or “at least one” and indefinite articles such as “a” or “an”; the same holds true for the use in the claims of definite articles. As used herein, the term “and/or” means either or both (or any combination or all of the terms or expressed referred to), e.g., “A, B, and/or C” encompasses A alone, B alone, C alone, A and B, A and C, B and C, and A, B, and C.

The present embodiments may be a system, a method, and/or a computer program product. In addition, selected aspects of the present embodiments may take the form of an entirely hardware embodiment, an entirely software embodiment (including firmware, resident software, micro-code, etc.) or an embodiment combining software and/or hardware aspects that may all generally be referred to herein as a “circuit,” “module” or “system.” Furthermore, aspects of the present embodiments may take the form of computer program product embodied in a computer readable storage medium (or media) having computer readable program instructions thereon for causing a processor to carry out aspects of the present embodiments. Thus embodied, the disclosed system, a method, and/or a computer program product are operative to provide improvements to transfer learning operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a dynamic or static random access memory (RAM), a read-only memory (ROM), an erasable programmable read-only memory (EPROM or Flash memory), a magnetic storage device, a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present embodiments may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server or cluster of servers. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present embodiments.

Aspects of the present embodiments are described herein with reference to flowchart illustrations and/or block diagrams of methods, apparatus (systems), and computer program products according to embodiments. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present embodiments. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Additional blocks not represented in the Figures may be included, for example, prior to, subsequent to, or concurrently with one or more illustrated blocks. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be appreciated that, although specific embodiments have been described herein for purposes of illustration, various modifications may be made without departing from the spirit and scope of the embodiments. In particular, transfer learning operations may be carried out by different computing platforms or across multiple devices. Furthermore, the data storage and/or corpus may be localized, remote, or spread across multiple systems. Accordingly, the scope of protection of the embodiments is limited only by the following claims and their equivalents.

What is claimed is:

1. A computer system comprising:
a processor operatively coupled to memory; and
a platform in communication with the processor and the memory, the platform comprising:
an artificial intelligence (AI) manager configured to leverage an AI model with respect to a target specification for a target standard, the AI model configured to identify at least one candidate control associated with a corresponding standard;
a mapping manager configured to traverse a map comprising source and destination controls, including to identify the at least one candidate control in the map and traverse the source and destination controls of the map to identify at least one mapped control associated with the target standard; and
a training manager configured to selectively train the AI model with the mapped control and the target standard.

2. The computer system of claim 1, wherein:
the AI model is configured to assess a score corresponding to the candidate control, the score representing similarity between the target specification and the candidate control; and
the mapping manager is configured to traverse the map responsive to the standard associated with the at least one candidate control being different than the target standard and/or to the corresponding score not satisfying a first threshold.

3. The computer system of claim 1, wherein the mapping manager is further configured to subject the traversal of the map to at least one parameter.

4. The computer system of claim 3 wherein the at least one parameter comprises a relationship confidence rating, a limit of a quantity of intermediate nodes between the source or destination controls, or a combination thereof.

5. The computer system of claim 3, wherein the mapping manager is further configured to change the at least one parameter and traverse the map responsive to the changed parameter.

6. The computer system of claim 1, wherein:
the mapping manager is further configured to map the at least one candidate control to a plurality of mapped controls associated with the target standard; and
the platform further comprises a scoring manager configured to rank the mapped controls.

7. The computer system of claim 1, wherein the platform further comprises a scoring manager configured to assess a score representing similarity between the at least one mapped control and the target specification.

8. A computer program product comprising
a computer readable storage device; and
program code embodied with the computer readable storage device, the program code executable by a processor to:
leverage an artificial intelligence (AI) model with respect to a target specification for a target standard, the AI model configured to identify at least one candidate control associated with a corresponding standard;
traverse a map comprising source and destination controls, the traverse comprising:
identify at least the candidate control in the map; and
traverse the source and destination controls of the map to identify at least one mapped control associated with the target standard; and
selectively train the AI model with the mapped control and the target standard.

9. The computer program product of claim 8, wherein:
the computer code executable by the processor to leverage the AI model comprises computer code executable by the processor to assess a score corresponding to the candidate control, the score representing similarity between the target specification and the candidate control; and
the computer code executable by the processor to traverse the map comprises computer code executable by the processor to traverse the map responsive to the standard associated with the at least one candidate control being different than the target standard and/or to the corresponding score not satisfying a first threshold.

10. The computer program product of claim 8, wherein the program code is executable by the processor to subject the traversal of the map to at least one parameter.

11. The computer program product of claim 10, wherein the at least one parameter comprises a relationship confidence rating, a limit of a quantity of intermediate nodes between the source or destination controls, or a combination thereof.

12. The computer program product of claim 10, wherein the program code is executable by the processor to change the at least one parameter and traverse the map responsive to the changed parameter.

13. The computer program product of claim 8, wherein the program code is executable by the processor to:
map the at least one candidate control to a plurality of mapped controls associated with the target standard; and
rank the mapped controls.

14. The computer program product of claim 8, wherein the program code is executable by the processor to assess a score representing similarity between the at least one mapped control and the target specification.

15. A method, comprising:
leveraging an artificial intelligence (AI) model with respect to a target specification for a target standard, the AI model identifying at least one candidate control associated with a corresponding standard;
traversing a map comprising source and destination controls, the traversing comprising:
using the computer processor, identifying at least the candidate control in the map; and
using the computer processor, traversing the source and destination controls of the map to identify at least one mapped control associated with the target standard; and
selectively training the AI model with the mapped control and the target standard.

16. The method of claim 15, wherein:
the leveraging the AI model comprises assessing a score corresponding to the candidate control, the score representing similarity between the target specification and the candidate control; and
the traversing of the map comprises traversing the map responsive to the standard associated with the at least one candidate control being different than the target standard and/or to the corresponding score not satisfying a first threshold.

17. The method of claim 15, wherein the traversing the map is subject the traversal of the map to at least one parameter.

18. The method of claim 17, wherein the at least one parameter comprises a relationship confidence rating, a limit of a quantity of intermediate nodes between the source or destination controls, or a combination thereof.

19. The method of claim 17, further comprising, using the computer processor, changing the at least one parameter and traversing the map responsive to the changed parameter.

20. The method of claim 15, wherein:
the traversing the map comprises mapping the at least one candidate control to a plurality of mapped controls associated with the target standard; and
the method further comprises ranking the mapped controls.

21. The method of claim 15, further comprising assessing a score representing similarity between the at least one mapped control and the target specification.

22. A computer system comprising:
a processor operatively coupled to memory; and
an in communication with the processor and the memory, the platform comprising:
an artificial intelligence (AI) manager configured to leverage an AI model with respect to a target specification for a target standard, the AI model configured to identify at least one candidate control associated with a corresponding standard;
a mapping manager configured to traverse a map comprising source and destination controls, including to:
identify the at least one candidate control in the map;
traverse the source and destination controls of the map to identify at least one mapped control associated with the target standard;
identify a quantity of identified mapped controls; and
selectively change a parameter of the traversal and re-traversing the source and destination controls of the map using the changed parameter; and
a training manager configured to selectively train the AI model with the at least one mapped control and the target standard.

23. The computer system of claim 22, wherein:
the AI model is configured to assess a score corresponding to the candidate control, the score representing similarity between the target specification and the candidate control; and
the mapping manager is configured to traverse the map responsive to the standard associated with the at least one candidate control being different than the target standard and/or to the corresponding score not satisfying a first threshold.

24. A method comprising:
leveraging an artificial intelligence (AI) manager with respect to a target specification for a target standard, the AI model configured to identify at least one candidate control associated with a corresponding standard;
traversing a map comprising source and destination controls, including:
identifying the at least one candidate control in the map;
traversing the source and destination controls of the map to identify at least one mapped control associated with the target standard, the at least one mapped control satisfying a first parameter;
identifying a quantity of identified mapped controls; and
selectively changing a parameter of the traversal and re-traversing the source and destination controls of the map using the changed parameter; and
selectively training the AI model with the at least one mapped control and the target standard.

25. The method of claim 24, wherein:
the leveraging the AI model comprises assessing a score corresponding to the candidate control, the score representing similarity between the target specification and the candidate control; and
the traversing of the map comprises traversing the map responsive to the standard associated with the at least one candidate control being different than the target standard and/or to the corresponding score not satisfying a first threshold.
